(19) United States
(12) Patent Application Publication
(10) Pub. No.: US 2013/0227407 A1
(43) Pub. Date: Aug. 29, 2013

(54) METHOD AND DEVICE FOR DISPLAYING AN ELECTRONIC DOCUMENT

(71) Applicants: PEKING UNIVERSITY FOUNDER GROUP CO., LTD., Beijing (CN); BEIJING FOUNDER APABI TECHNOLOGY LTD., Beijing (CN)

(72) Inventors: Liang WANG, Beijing (CN); Wei ZHAO, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/779,357

(22) Filed: Feb. 27, 2013

(30) Foreign Application Priority Data
Feb. 29, 2012 (CN) 201210050874.9

(51) Int. Cl. G06F 17/21

(52) U.S. Cl. CPC G06F 17/211
USPC 715/273

(57) ABSTRACT

A method for displaying an electronic document includes obtaining a reading mark of the electronic document, which is recorded at a last display of the electronic document; identifying a content of the electronic document corresponding to the reading mark under a current reading mode; and displaying the identified content. A reading device that performs the disclosed method is also provided.

### CROSS REFERENCE TO RELATED APPLICATIONS

This application claims the benefit of Chinese Patent Application No. 201210050874.9, filed on Feb. 29, 2012, which is incorporated herein by reference in its entirety as part of this application.

### TECHNICAL FIELD

The present application relates to communication fields, and in particular, to a method and a device for displaying an electronic document.

### BACKGROUND

An electronic document can be displayed in different modes, for example, a fixed-layout display mode and a flow-layout display mode. The fixed-layout display mode has its layout fixed, which can maintain the layout and arrangement of the characters, numerals, tables, figures and the like in the document on various displaying devices. During reading on an electronic reading device, the electronic document is displayed in the original layout. The electronic document will not be re-typeset based on parameters of a screen, such as the width of the screen. That is, the electronic document will be displayed with the same layout on various devices using different programs. The printout of the electronic document is also consistent with the display of the document on an electronic reading device, such as a computer. Moreover, the display of the electronic document on various devices are consistent with each other, and consistent with the original layout of the document. Under the flow-layout display mode, the arrangement of the characters, numerals, tables and figures or the like in the electronic document are processed, and the original editing elements of the electronic document are stored and can be auto-adaptively displayed with scaling to adapt the display of the electronic document to the parameters of the screen, such as the width of the screen. For example, when the document is displayed on an e-book reader with a small screen, the numbers of lines in a paragraph of the document can be adjusted based on the width of the screen.

Moreover, under the fixed-layout display mode, the document is displayed by pages. The whole document is divided into many pages and the layout is fixed on each page. In contrast, under the flow-layout display mode, the whole document is displayed sequentially since there is no page concept for the flow-layout display mode.

Some e-reading programs can support both of the fixed-layout display mode and the flow-layout display mode and allow switching between the two display modes. However, there are deficiencies in switching between the fixed-layout display mode and the flow-layout display mode. For example, an electronic document may be displayed under a fixed-layout display mode and later under a flow-layout display mode, and certain elements of the flow-layout document may not be automatically located at their respective corresponding locations in the fixed-layout document. A reader may need to manually find their respective corresponding locations in the fixed-layout document. For example, a user reads an e-book using a desktop computer under a fixed-layout display mode from the beginning to a certain location, and then continues to read the e-book using a portable terminal with a small screen. The portable terminal needs to switch to a flow-layout display mode so as to make contents of the e-book auto-adaptive to the size of the screen of the portable terminal. However, the e-book cannot auto-position the last location displayed under the fixed-layout display mode on the desktop computer. The user may need to manually find the last location displayed under the flow-layout display mode on the portable terminal. For this reason, the user's reading efficiency and experience may be affected.

### SUMMARY

The present invention provides a method and a device for displaying an electronic document, which can improve the fluency and efficiency of reading the electronic document.

According to some embodiments, a method for displaying an electronic document includes obtaining a reading mark of the electronic document, which is recorded at a last display of the electronic document, identifying a content of the electronic document corresponding to the reading mark under a current reading mode; and displaying the content.

The present invention provides a method for displaying an electronic document. According to some embodiments, the method includes obtaining a reading mark of the electronic document, the reading mark being recorded under a first reading mode, identifying a content of the electronic document under a second reading mode based on the reading mark, wherein the second reading mode is different from the first reading mode, and displaying the identified content under the second reading mode.

The present invention also provides a device for displaying an electronic document. According to some embodiments, the device includes an obtaining module configured to obtain a reading mark of the electronic document, which is recorded at a last display of the electronic document, a searching module configured to search the electronic document to identify a content corresponding to the reading mark under a current reading mode, and a displaying module configured to display the identified content.

The present invention also provides a non-transitory, tangible computer readable storage medium encoded with a program, when executed by a processor, performs a method for displaying an electronic document. According to some embodiments, the method includes obtaining a reading mark of the electronic document, which is recorded at a last display of the electronic document, identifying a content of the electronic document corresponding to the reading mark under a current reading mode, and displaying the identified content.

The present invention provides a method and a device for obtaining a reading mark of the electronic document, which is recorded at a last or most recent display of the electronic document, searching the electronic document to identify a content corresponding to the reading mark under a current reading mode, and displaying the identified content on a currently displayed page. With the method and device for displaying an electronic document provided by the disclosed embodiments, the electronic document is divided into reading blocks under different reading modes, and a reading mark of the reading block corresponding to the content displayed on a current page is recorded at an end of each display of the electronic document. When the electronic document is to be displayed again, the corresponding content is identified through searches according to the recorded reading mark, and is displayed.

### BRIEF DESCRIPTION OF THE DRAWINGS

FIG. 1 schematically shows a flow chart of a method for displaying an electronic document according to an embodiment of the present invention;

FIGS. 2a-2c schematically show a division into reading blocks according to an embodiment of the present invention;

FIG. 3 schematically shows a flow chart of a method for displaying an electronic document according to another embodiment of the present invention;

FIGS. 4a-4d schematically show a display of an electronic document under different reading modes according to an embodiment of the present invention; and

FIG. 5 schematically shows a device for displaying an electronic document according to another embodiment of the present invention.

### DETAILED DESCRIPTION

Hereinafter, embodiments of the present invention will be described in detail with reference to the accompanying drawings.

The present invention provides a method for displaying an electronic document. As shown in FIG. 1, according to some embodiments, the method may comprise:
step 101: obtaining a reading mark of the electronic document, which is recorded at a last display of the electronic document;
step 102: identifying a content of the electronic document corresponding to the reading mark under the current reading mode; and
step 103: displaying the identified content.

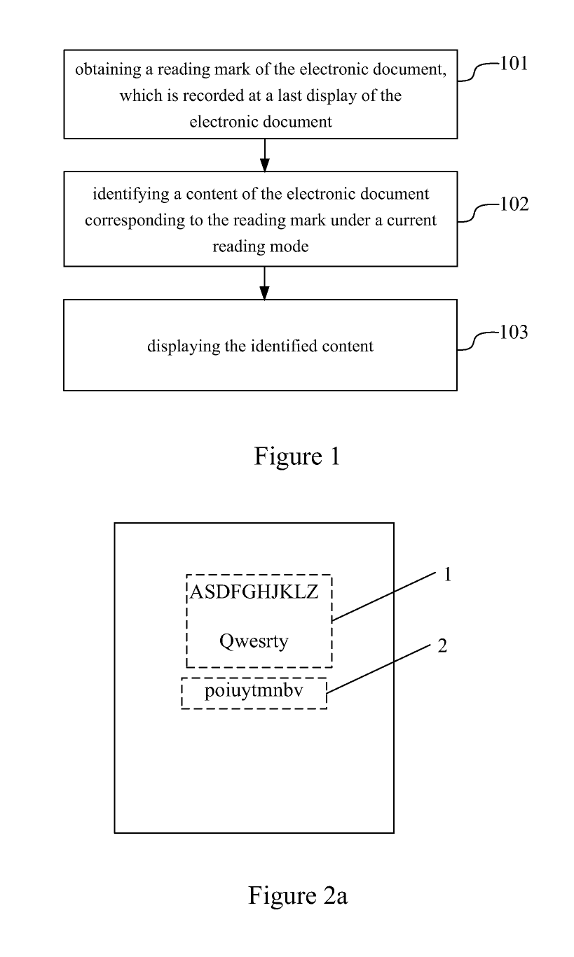

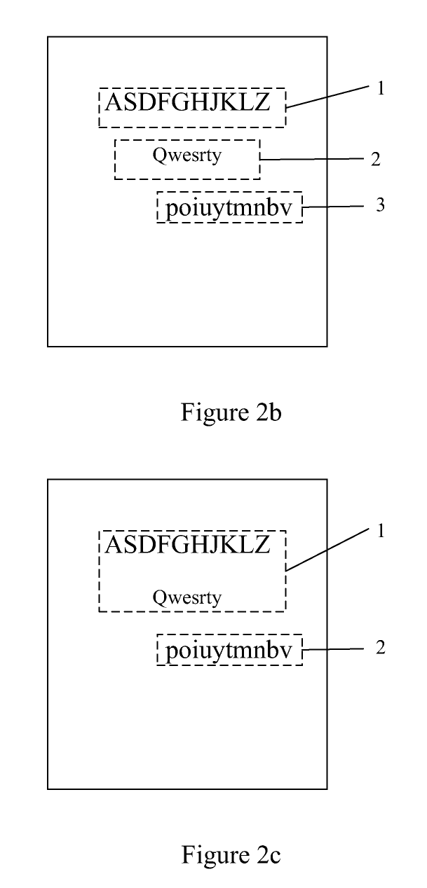

The electronic document may be divided into multiple reading blocks under a reading mode (e.g., a fixed-layout reading mode or a flow-layout reading mode). A unique reading mark may be added to each reading block. The manners for dividing into reading blocks under each reading mode may be same or different from each other. For example, as shown in FIG. 2a, under a fixed-layout reading mode, the electronic document may be divided into a reading block 1 and a reading block 2. As shown in FIG. 2b, under a flow-layout reading mode, the electronic document may be divided into a reading block 1, a reading block 2 and a reading block 3. Or, as shown in FIG. 2c, the electronic document may be divided into a reading block 1 and a reading block 2 under both of the fixed-layout reading mode and flow-layout reading mode.

In some embodiments, each time before the electronic document is displayed, the reading device, for example, an e-book reader can determine whether the electronic document has been divided into reading blocks under each reading mode. If no, the reading device may divide the electronic document into reading blocks under the reading mode that the electronic document has not been divided. Each reading block can be marked with a unique reading mark. When the document is divided into reading blocks, the reading device may determine whether the electronic document includes block information under a fixed-layout reading mode. If yes, the reading device may divide the electronic document into reading blocks according to the block information. If no, the reading device may divide the electronic document into reading blocks according to characters, sentences, and/or paragraphs. For example, a CEBX (Common e-Document of Blending XML(Extensible Markup Language)) electronic document includes block information under a fixed-layout reading mode, and the PDF electronic document does not include such block information.

An electronic document may be divided into reading blocks with relatively small size or large size. If the document is divided into relatively small reading blocks, the positioning accuracy of reading is relatively high, but, information, such as reading marks, to be stored will be in larger size. If the document is divided into relatively large reading blocks, the positioning accuracy of reading is relatively low, but, information, such as reading marks, to be stored will be less. A user may choose how to divide the electronic document into reading blocks with suitable sizes, according to the length of the electronic document and other information, such as a user's preference.

Moreover, each reading block may include location information. For example, the location information of a reading block obtained under the fixed-layout reading mode may include information on page numbers, line numbers, and character numbers, such as page XX, line XX, character XX. Since the flow-layout document does not include pages, the location information of a reading block obtained under the flow-layout reading mode may include line numbers and character numbers, for example line XX, character XX.

When a reading device constructed according to embodiments of the present invention opens an electronic document, depending on a current reading mode and a previous reading mode, the reading device may use different methods to search the electronic document to identify the right location that the user would want to read.

For example, in a first scenario, the reading device obtains a reading mark of the electronic document recorded at a last display of the electronic document. If the electronic document is divided into reading blocks in the same way in the fixed-layout reading mode as in the flow-layout reading mode, the reading marks are consistent under the fixed-layout reading mode and the flow-layout reading mode. In this scenario, the reading device can search the electronic document to identify the content corresponding to the reading mark under the current reading mode no matter what the last reading mode is under which the reading mark is recorded. The content found through the search is then displayed on the reading device under the current reading mode.

For another example, in a second scenario, the reading device obtains a reading mark of the electronic document recorded at a last display of the electronic document. The electronic document may be divided into reading blocks in different ways under the last reading mode when the reading mark is recorded and the current reading mode. In this scenario, the reading device may search the electronic document to identify a content corresponding to the reading mark under the reading mode when the reading mark was recorded. After the content is identified, the reading device may identify a current reading mark under the current reading mode according to the identified content. The reading device may then search the electronic document under the current reading mode to identify a content corresponding to the current reading mark. After the content under the current reading mode is identified, the reading device may display the identified content under the current reading mode.

For example, “abcdefg” can be divided into (1) “abc” and (2) “defg” under a fixed-layout reading mode, and into (1) “ab”, (2) “cd” and (3) “efg” under a flow-layout reading mode. In this scenario, the last reading mode when the reading mark is recorded can be a fixed-layout reading mode and the current reading mode can be a flow-layout reading mode. The recorded reading mark is (2) under the last reading mode which is the fixed-layout reading mode. The reading device first searches the electronic document to identify a content corresponding to the reading mark (2) under the fixed-layout reading mode, which is “defg.” The reading device then searches under the flow-layout reading mode for a reading mark that corresponds to the content “defg,” and identify the reading mark (2) under the flow-layout reading mode. The reading device then search and identify the content, which is “cd,” corresponding the reading mark (2) under the flow-layout reading mode. The reading device can then display the content starting from “cd” in the first line of the screen under the flow-layout reading mode. When the current display is interrupted, the reading mark of the reading block corresponding to a preset location on a page currently displayed is obtained and recorded. The preset location may be the first line, last line or any line set by a user.

In some embodiments, when displaying the content found through the searches under the current reading mode, the content may be displayed in the first line, last line or any line on the currently displayed page.

The above-disclosed method is not only suitable for displaying the document on the same device at different times and/or under different reading modes, but also for displaying the document on different devices. The reading blocks of the document obtained under each reading mode, the reading mark recorded at the end of each display of the document can be moved or copied from one device to another device together with the document, as attribute information of the document.

It can be seen from the above that in the method for displaying an electronic document provided by the embodiment, the electronic document is divided into reading blocks under different reading modes, and a reading mark of the reading block corresponding to the content displayed on a current page is recorded at an end of a last display of the electronic document. When the electronic document is to be displayed again, the corresponding content is identified according to the recorded reading mark, and is displayed. Moreover, when a current reading mode is different from a previous reading mode under which the reading mark is recorded, the corresponding content can also be identified quickly and displayed under the current reading mode. Thus, the fluency and efficiency of reading an electronic document can be improved.

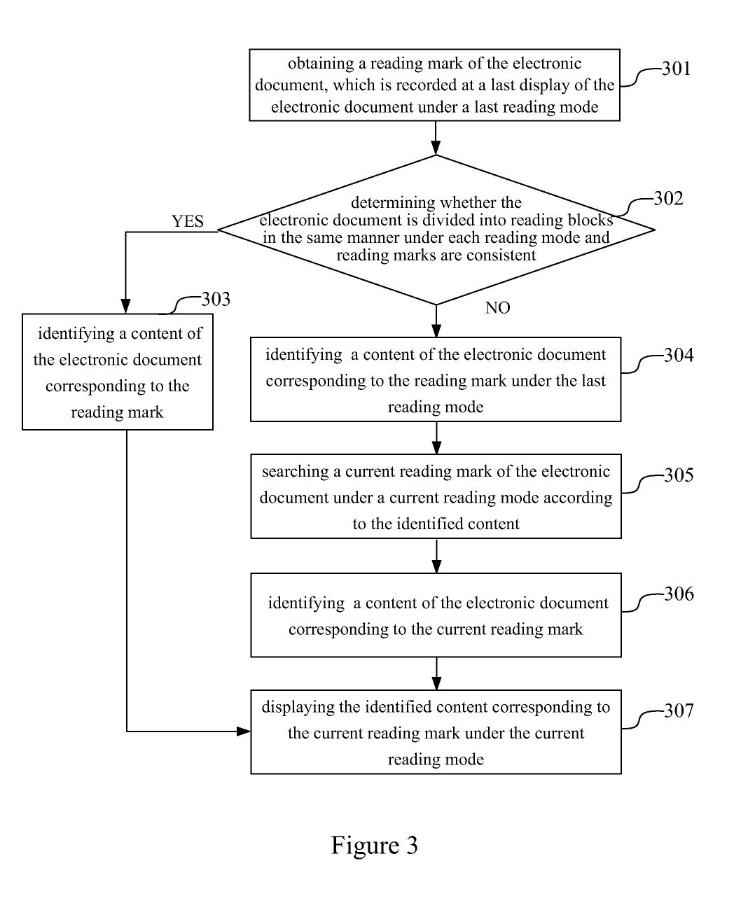

A method for displaying an electronic document according to some embodiments of the present invention will be described in detail with reference to the following examples. As shown in FIG. 3, when the electronic document is to be displayed after it is divided into reading blocks, the method may comprise the following steps:
step 301: obtaining a reading mark of the electronic document, which is recorded at a last display of the electronic document;
step 302: determining whether the electronic document is divided into reading blocks in the same manner under each of a fixed-layout reading mode and a flow-layout reading mode, and reading marks are consistent under both reading modes; if yes, going to step 303, otherwise going to step 304;
step 303: searching the electronic document to identify a content corresponding to the reading mark and then going to step 307;
step 304: searching the electronic document to identify a content corresponding to the reading mark under a reading mode under which the reading mark is recorded;
step 305: identifying a current reading mark of the electronic document under the current reading mode according to the identified content;
step 306: searching the electronic document to identify a content corresponding to the current reading mark; and
step 307: displaying the identified content under the current reading mode corresponding to the current reading mark. The content can be displayed from the first line of the screen or from other locations on the screen.

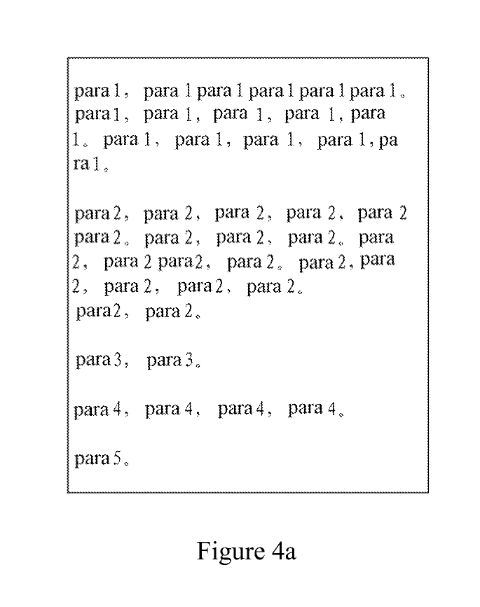

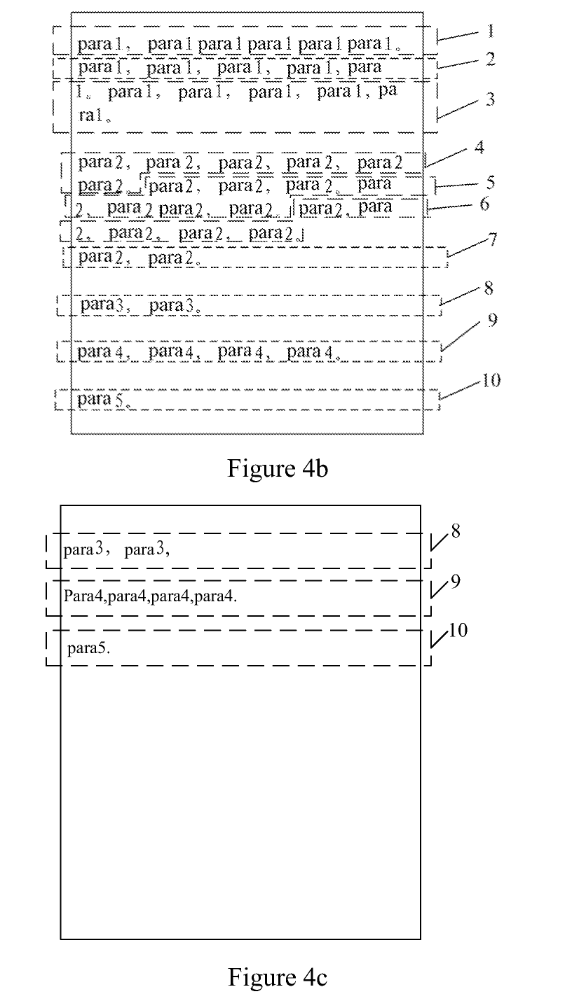

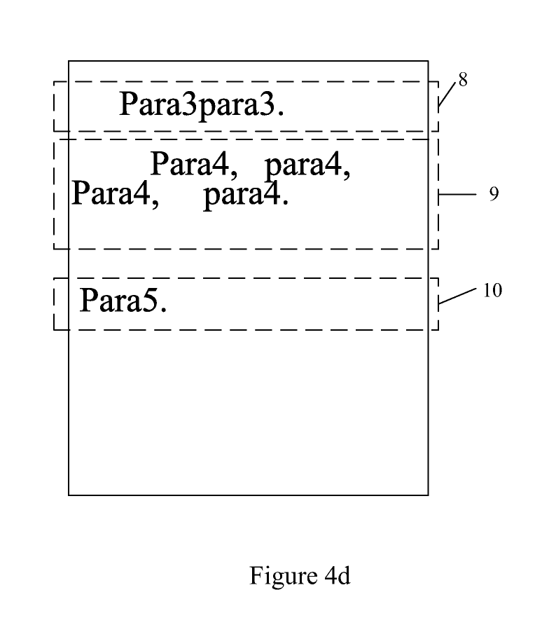

For another example, assuming that the contents of an electronic document are as shown in FIG. 4a, the electronic document may be divided into reading blocks in the same manner under each of the fixed-layout and flow-layout reading modes and reading marks under each reading mode are consistent. As shown in FIG. 4b, paragraph 1 is divided into three reading blocks with respective reading marks 1, 2 and 3. Paragraph 2 is divided into four reading blocks with respective reading marks 4, 5, 6 and 7. Paragraph 3 is divided into one reading block with a reading mark 8. Paragraph 4 is divided into one reading block with a reading mark 9. Paragraph 5 is divided into one reading block with a reading mark 10. As shown in FIG. 4c, paragraph 3 is displayed in the first line under a fixed-layout reading mode. If an interruption of the reading of the document occurs at this time, the reading mark 8 is recorded. When the document is displayed under a flow-layout reading mode, paragraph 3 is identified by searches based on the recorded reading mark 8, and then paragraph 3 is displayed in the first line under the flow-layout reading mode, as shown in FIG. 4d. Other manners for dividing the document are essentially the same as the above manner and are not described in detail. If a previous reading mode (e.g., a fixed-layout reading mode) under which the reading mark is recorded is different from a current reading mode (e.g., a flow-layout reading mode), the principle of searching and identifying the content to be displayed under the current reading mode is the same as described in the above sections, for example including identifying a content corresponding to the reading mark under the previous reading mode, identifying a current reading mark corresponding to the identified content under the current reading mode, and identifying a content corresponding to the current reading mark under the current reading mode.

It can be seen from the above that in the method for displaying an electronic document provided by the embodiments, the electronic document is divided into reading blocks under different reading modes, and a reading mark of the reading block corresponding to the content displayed on a current page is recorded at the end of a last display. When the electronic document is to be displayed again, the corresponding content is identified according to the recorded reading mark, and is displayed. If a current reading mode is different from a previous reading mode under which the reading mark is recorded, the corresponding content can also be found and displayed under the current reading mode. And thus, the fluency and efficiency of reading an electronic document can be improved.

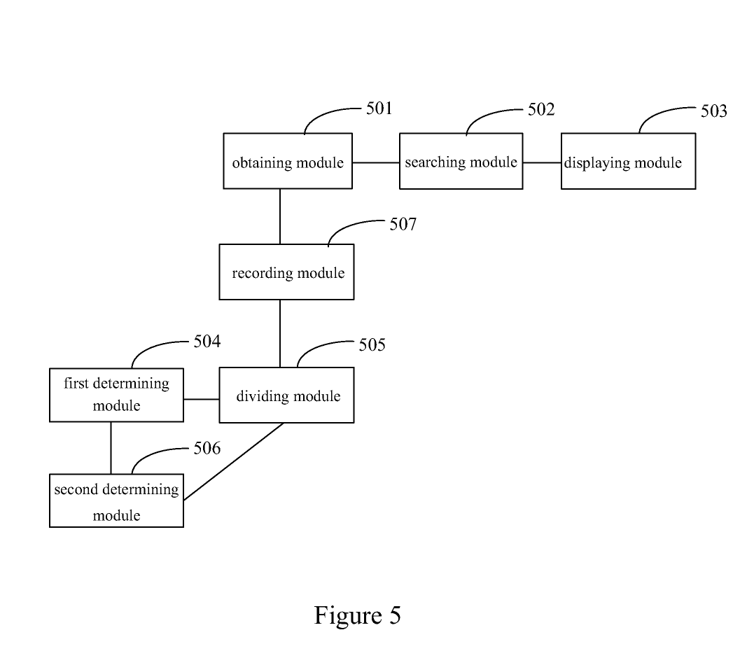

The present invention also provides a device for displaying an electronic document. According to one embodiment, as shown in FIG. 5, the device may comprise:
an obtaining module 501 configured to obtain a reading mark of the electronic document, which is recorded at a last display of the electronic document;
a searching module 502 configured to search the electronic document to identify a content corresponding to the reading mark under a current reading mode; and
a displaying module 503 configured to display the identified content on the device under the current reading mode.

In some embodiments, the device may further comprise:
a first determining module 504 configured to determine whether the electronic document has been divided into reading blocks under each reading mode (e.g., a fixed-layout reading mode and a flow-layout reading mode); and
a dividing module 505 configured to divide the electronic document into reading blocks and mark each reading block with a unique reading mark if the first determining module 504 determines that the electronic document has not been divided into reading blocks under a reading mode.

In some other embodiments, the device may further comprise:
a second determining module 506 configured to determine whether the electronic document includes block information under a fixed-layout reading mode;
if yes, the second determining module 506 may inform the dividing module 505 to divide the document into reading blocks based on the block information; and
if no, the second determining module 506 may inform the dividing module 505 to divide the electronic document into reading blocks based on characters, sentences and/or paragraphs.

In some other embodiments, the device may further comprise:
a recording module 507 configured to obtain and record the reading mark of the reading block corresponding to a preset location on the current page at the end of a display of the electronic document.

In some further embodiments, the searching module 502 may be further configured to:
if the electronic document is divided into reading blocks in the same way under the fixed-layout mode as under the flow-layout mode, and the reading marks are consistent under each reading mode, search the electronic document to identify the content corresponding to the reading mark under a current reading mode; and
if the electronic document is divided into reading blocks in different ways under the last reading mode and the current reading mode, search the electronic document to identify the content corresponding to the reading mark under the last reading mode, search a current reading mark under the current reading mode according to the identified content, and search the electronic document to identify the content corresponding to the current reading mark under the current reading mode.

It can be seen from the above that, with the method and device for displaying an electronic document provided by the embodiments, the electronic document can be divided into reading blocks under different reading modes, and a reading mark of the reading block corresponding to the content displayed on the current page is recorded at the end of a display of the electronic document. When the electronic document is to be displayed again, the corresponding content can be identified according to the recorded reading mark, and can be displayed. Moreover, when a current reading mode is different from a previous reading mode when the reading mark is recorded, the corresponding content can be identified quickly and displayed under the current reading mode. And thus, the fluency and efficiency of reading an electronic document can be improved.

A person with ordinary skill in the art will understand that the embodiments of the present application can be a method, a system, or a computer program product. Therefore, the embodiments of the present application may be implemented by hardware, software, or a combination thereof. In addition, the embodiments of the present application may be implemented as a computer program product embodied on one or more non-transitory, tangible computer-readable storage mediums (comprising but not limited to disk storage, CD-ROM, optical memory and the like) containing a computer-readable program code.

The present application has been described with reference to the flow charts and/or block diagrams of the method, the device (the system), and the computer program product according to the some embodiments of the present application. It can be understood that each flow of the flow charts and/or each block of the block diagrams and the combination thereof can be implemented by computer program instructions. Such computer program instructions can be provided to a general computer, a specified computer, an embedded processor, or processors of other programmable data processing apparatus to generate a machine, such that a device is generated via the instructions executed on the computer or processor of other programmable data processing apparatus, and the device is configured to implement the specific function of one or more flows in the flow charts and/or one or more blocks in the block diagrams.

Such computer program instructions can also be stored in a computer readable memory which can direct the computer or other programmable data processing apparatus to work in a particular way, such that the instructions stored in the computer readable memory generate a device which is configured to implement the specific function of one or more flows in the flow charts and/or one or more blocks in the block diagrams.

Such computer program instructions can also be loaded on a computer or other programmable data processing apparatus, such that a series of operation steps can be executed on the computer or other programmable data processing apparatus to generate a computer implemented processing so as to provide the progress which can implement the specific function of one or more flows in the flow charts and/or one or more blocks in the block diagrams.

Although the preferable embodiments of the present application have been described, various changes and modifications to the embodiments can be made once the skilled in the art have learned the basic creative concept. Thus, the appended claims intend to be explained as comprising the preferable embodiments and all the changes and modifications within the scope of the invention.

Apparently, various variants and modifications to the invention can be made by the skilled in the art without departing from the spirit and scope of the present invention. If such variants and modifications to the invention belong to the scope of the claims and their equivalents, the invention intends to comprise such variants and modifications.

What is claimed is:

1. A method for displaying an electronic document, comprising:
obtaining a reading mark of the electronic document, the reading mark being recorded under a first reading mode;
identifying a content of the electronic document under a second reading mode based on the reading mark, wherein the second reading mode is different from the first reading mode; and
displaying the identified content under the second reading mode.

2. The method according to claim 1, wherein the first reading mode is one of a fixed-layout reading mode and a flow-layout reading mode.

3. The method according to claim 1, wherein the identifying a content of the electronic document under a second reading mode based on the reading mark comprises:
identifying a content of the electronic document corresponding to the reading mark under the first reading mode;
identifying a second reading mark under the second reading mode corresponding to the content identified under the first reading mode; and
identifying a content of the electronic document corresponding to the second reading mark under the second reading mode.

4. The method according to claim 1, further comprising:
dividing the electronic document into reading blocks under the first reading mode, and assigning a reading mark to each reading block; and
dividing the electronic document into reading blocks under the second reading mode, and assigning a reading mark to each reading block.

5. The method according to claim 1, further comprising:
dividing the electronic document into reading blocks according to block information under a fixed-layout reading mode.

6. A method for displaying an electronic document, comprising:
obtaining a reading mark of the electronic document, which is recorded at a last display of the electronic document;
identifying a content of the electronic document corresponding to the reading mark under a current reading mode; and
displaying the identified content.

7. The method according to claim 6, further comprising:
determining whether the electronic document has been divided into reading blocks under each of a fixed-layout and a flow-layout reading mode; and
if the electronic document is not divided under one or more of the fixed-layout reading mode and the flow-layout reading mode, dividing the electronic document into reading blocks under the one or more of the reading modes and marking each of the reading blocks with a reading mark.

8. The method according to claim 7, wherein the dividing the electronic document into reading blocks comprises:
determining whether the electronic document includes block information under a fixed-layout reading mode;
if yes, dividing the electronic document into reading blocks based on the block information under the fixed-layout reading mode; and
if no, dividing the electronic document into reading blocks based on characters, sentences, or paragraphs.

9. The method according to claim 8, further comprising:
obtaining the reading mark of the reading block corresponding to a preset location on a page that is displayed at the last display of the electronic document.

10. The method according to claim 6, wherein the identifying a content of the electronic document corresponding to the reading mark under a current reading mode comprises:
determining whether the current reading mode is the same as a previous reading mode under which the reading mark is recorded;
if it is the same, searching the electronic document to identify the content corresponding to the reading mark; and
if it is not the same, identifying the content of the electronic document corresponding to the reading mark under the previous reading mode under which the reading mark is recorded, identifying a current reading mark under the current reading mode corresponding to the content identified under the previous reading mode, and identifying a content of the electronic document corresponding to the current reading mark under the current reading mode.

11. A device for displaying an electronic document, comprising:
an obtaining module configured to obtain a reading mark of the electronic document, which is recorded at a last display of the electronic document;
a searching module configured to search the electronic document to identify a content of the electronic document corresponding to the reading mark under a current reading mode; and
a displaying module configured to display the identified content on the device.

12. The device according to claim 11, further comprising:
a first determining module configured to determine whether the electronic document has been divided into reading blocks under each of a fixed-layout reading mode and a flow-layout reading mode; and
a dividing module configured to divide the electronic document into reading blocks and mark each of the reading blocks with a reading mark under each of a fixed-layout reading mode and a flow-layout reading mode.

13. The device according to claim 12, further comprising:
a second determining module configured to determine whether the electronic document includes block information under the fixed-layout reading mode, wherein the second determining module is further configured to inform the dividing module to divide the electronic document into reading blocks based on the block information under the fixed-layout reading mode if the electronic document includes the block information, and inform the dividing module to divide the electronic document into reading blocks based on characters, sentences, or paragraphs if the electronic document does not include the block information.

14. The device according to claim 11, further comprising:
a recording module configured to obtain the reading mark of the reading block corresponding to a preset location on a page that is displayed at the last display of the electronic document.

15. The device according to claim 11, wherein the searching module is further configured to:
determine whether the current reading mode is the same as a previous reading mode under which the reading mark is recorded;
if it is the same, search the electronic document to identify the content corresponding to the reading mark; and
if it is not the same, identify the content of the electronic document corresponding to the reading mark under the previous reading mode under which the reading mark is obtained, identify a current reading mark under the current reading mode according to the identified content, and search the electronic document to identify a content of the electronic document corresponding to the current reading mark.
